(19) United States
(12) Patent Application Publication
(10) Pub. No.: US 2012/0045132 A1
(43) Pub. Date: Feb. 23, 2012

(54) METHOD AND APPARATUS FOR LOCALIZING AN OBJECT WITHIN AN IMAGE

(75) Inventors: Tak-Shing Wong, West Lafayette, IN (US); Farhan Baqai, Fremont, CA (US); Soo Hyun Bae, San Jose, CA (US)

(73) Assignee: SONY CORPORATION, Tokyo (JP)

(21) Appl. No.: 12/861,410

(22) Filed: Aug. 23, 2010

(51) Int. Cl. G06K 9/46

(52) U.S. Cl. 382/195

(57) ABSTRACT

An improved method and apparatus for localizing objects within an image is disclosed. In one embodiment, the method comprises accessing at least one object model representing visual word distributions of at least one training object within training images, detecting whether an image comprises at least one object based on the at least one object model, identifying at least one region of the image that corresponds with the at least one detected object and is associated with a minimal dissimilarity between the visual word distribution of the at least one detected object and a visual word distribution of the at least one region and coupling the at least one region with indicia of location of the at least one detected object.

### BACKGROUND

1. Technical Field

Embodiments of the present invention generally relate to image processing techniques and, more particularly, to a method and apparatus for localizing an object within an image.

2. Description of the Related Art

Advancements in computer technology have led to the production and storage of large amounts of data. The data generally comprises images, videos, text files and the like. It is well known in the art that various text searching algorithms are used to extract text information from the data. Similarly, it is desirable to extract information, for example, position and motion information for particular content (e.g., objects, such as human face, cars, vehicles and the like) within the images and/or video.

Various image processing. techniques are developed to identify a particular object within the images and/or video frames. In one technique, a user manually identifies the particular object within the images and associates a particular textual tag with the particular object. As a result, each image having the particular textual tag is searchable within the data using the well known text searching algorithms. However, such image processing techniques needs significant human intervention to identify and locate the objects within the images.

In another technique, object specific information (e.g., color histogram, object shape, size and the like) is defined for a plurality of objects associated with a particular type (i.e., object type). If an image possesses or contains the same or similar object specific information, an object instance of the particular type is most likely present within the image. However, when an input image includes conditions such as varied luminance, different viewing angle, cluttered background, scale variation and among others, the specific information associated with the particular object is significantly varied, incomplete or unavailable. In addition, if the particular object is occluded or partly blocked within the input image, the present techniques cannot detect the particular object. The specific information generated for one object cannot be generalized or compared with the specific information for another object (e.g., a human face, a bicycle and the like). When the input image is processed, these techniques cannot identify objects that match a known object based on similarities in the object specific information.

Therefore, there is a need in the art for an improved method and apparatus for localizing objects within an image.

### SUMMARY

Various embodiments of the present disclosure comprise a method and apparatus for localizing objects within an image. In one embodiment, a computer implemented method for localizing objects within an image comprises accessing at least one object model representing visual word distributions of at least one training object within training images, detecting whether an image comprises at least one object based on the at least one object model, identifying at least one region of the image that corresponds with the at least one detected object and is associated with a minimal dissimilarity between the visual word distribution of the at least one detected object and a visual word distribution of the at least one region and coupling the at least one region with indicia of location of the at least one detected object.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope; for the invention may admit to other equally effective embodiments.

FIG. 1 illustrates a computer system for detecting and localizing an object within an image in accordance with one or more embodiments of the invention;

FIG. 2 illustrates a process for detecting and localizing an object within an image in accordance with one or more embodiments of the invention;

FIGS. 3A-C illustrate a flow diagram of a method for defining visual words and creating object models in accordance with the one or more embodiments of the invention;

FIG. 4 illustrates a flow diagram of a method for detecting an object within the image in accordance with one or more embodiments of the invention; and

FIG. 5 illustrates a flow diagram of a method for identifying regions of an image that form an object in accordance with one or more embodiments of the invention;

FIG. 6 illustrates a simulated annealing optimization process for identifying one or more regions of an image that form an object in accordance with one or more embodiments; and

FIG. 7 illustrates a flow diagram of a method of generating a new proposal solution from a current solution for use in a simulated annealing process in accordance with one or more embodiments.

### DETAILED DESCRIPTION

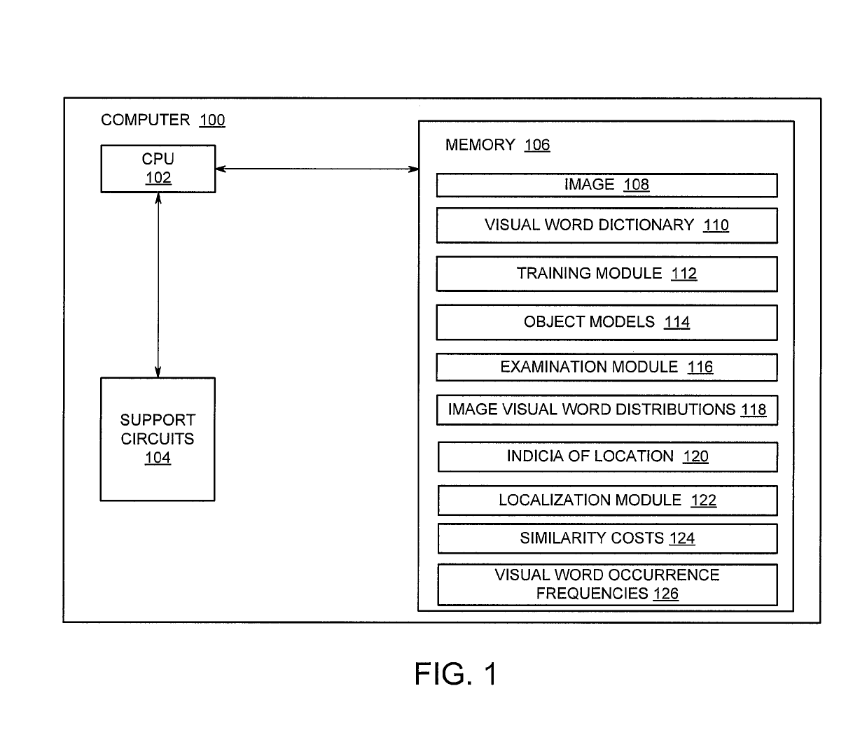

FIG. 1 illustrates a computer system 100 that is configured to localize objects within an image in accordance with one or more embodiments of the invention. The computer system 100 is configured to utilize high level information (i.e., visual words) in combination with image segmentation to detect and/or localize some of the objects therein.

The computer system 100 comprises a Central Processing Unit (CPU) 102, for example, a microprocessor or a microcontroller, support circuits 104, and a memory 106 as generally known in the art. The various support circuits 104 facilitate operation of the CPU 102 and may include clock circuits, buses, power supplies, input/output circuits and/or the like. The memory 106 includes a read only memory, random access memory, disk drive storage, optical storage, removable storage, and the like. The memory 106 includes various software packages, such as a training module 112, an examination module 116 and a localization module 122. The memory 106 also includes various data, such as an image 108, visual word dictionary 110, object models 114, image visual word distributions 118, indicia Of location 120, similarity costs 124 and visual word occurrence frequencies 126.

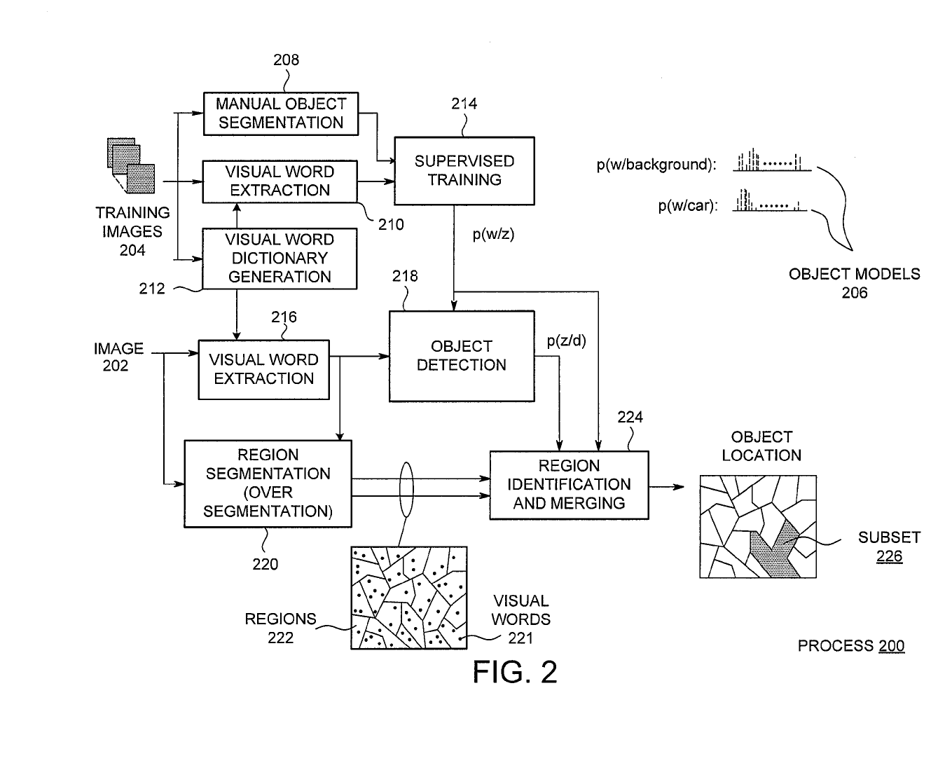

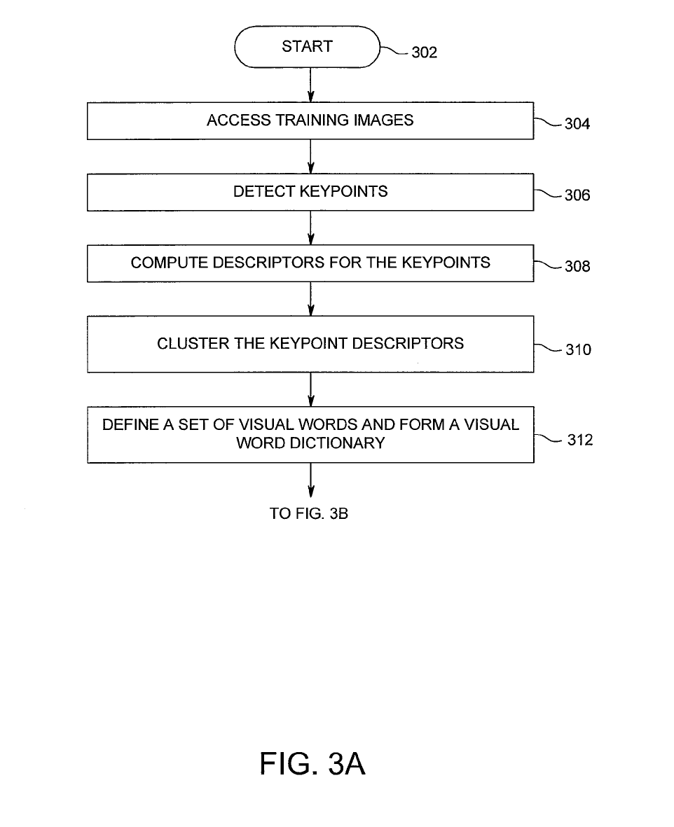

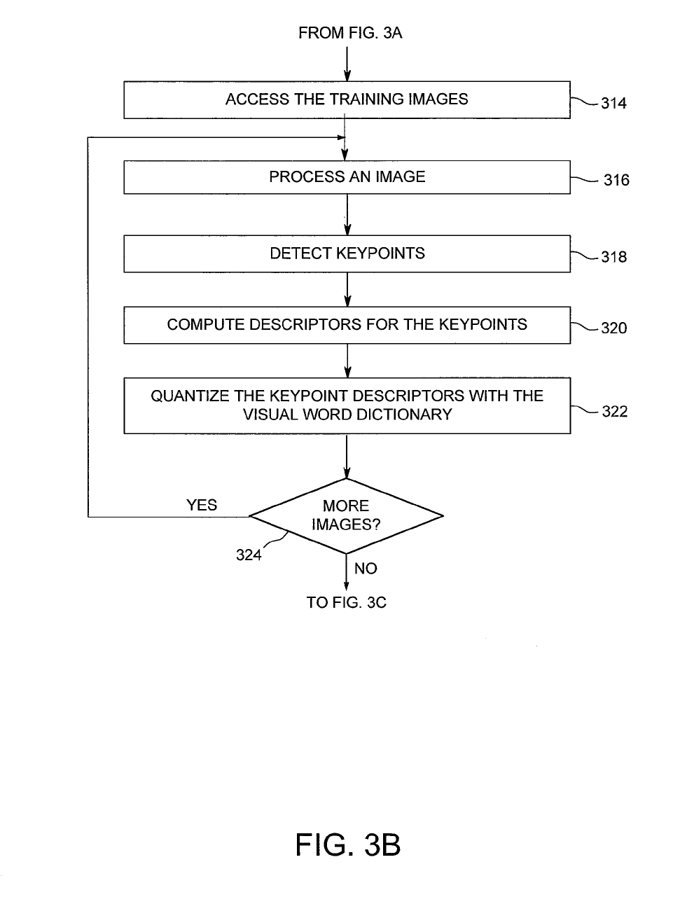

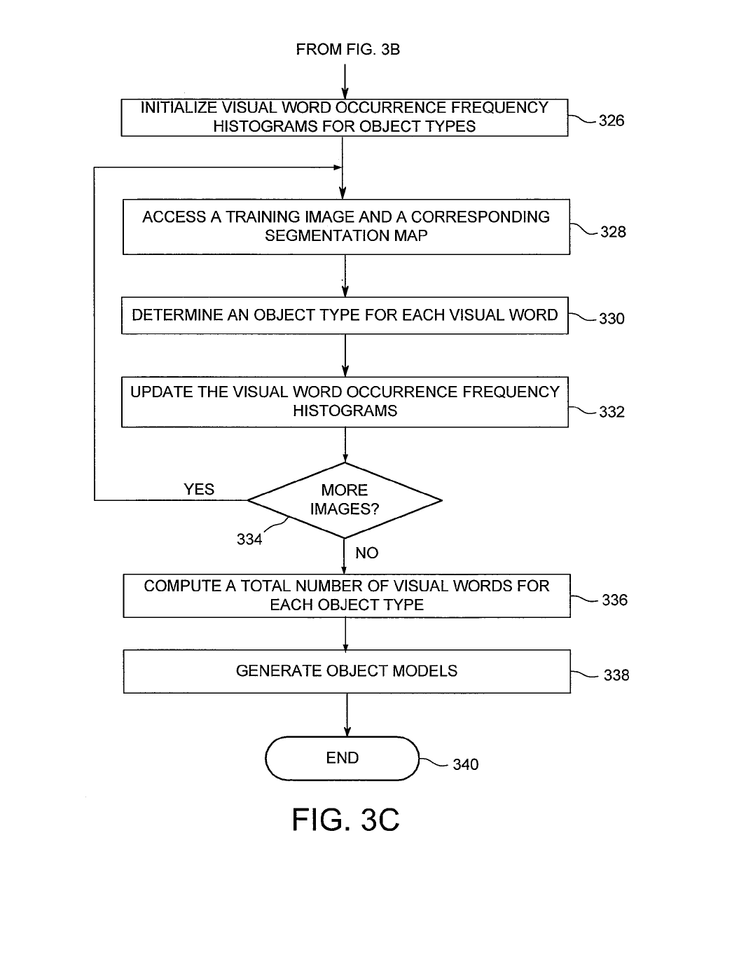

Using a plurality of training images, the training module 112 is configured to generate the visual word dictionary 110 and the object models 114. The visual word dictionary 110 includes definitions for a plurality of visual words. Each object model 114 defines an object using a distribution (e.g., a normalized frequency distribution) of the plurality of visual words within one or more regions that comprise the object. The process for generating the visual word dictionary 110 and the object models 114 are explained in detail below in the description for FIG. 2 and FIGS. 3A-C.

Prior to generating the visual word dictionary 110, the training module 112 detects salient portions (hereinafter, referred to as keypoints) within each training image that include information, which is important for object detection and identification, using well-known keypoint detector algorithms (e.g., difference of Gaussian detector). After detection of these keypoints, the training module 112 computes descriptors for representing the detected keypoints. A keypoint descriptor, generally, is a vector that represents scale/affline invariant image portions. Keypoints represented by high dimensional keypoint descriptors are robust to changes in scale, viewpoint and lighting condition.

Using well known clustering algorithms (e.g., K-means clustering algorithm and the like), the training module 112 clusters these keypoint descriptors into groups according to similarity and determines a representative keypoint descriptor for each group. The representative keypoint descriptor is referred to as a visual word. In one embodiment, the visual word is defined as an average of the keypoint descriptors, which are clustered into a group. The training module 112 stores each visual word in the visual word dictionary 110. As a consequence, any software module within the computer system 100 may access the visual word dictionary 110 to determine whether a particular visual word is present within any image, such as the image 108 or another training image. For example, if a visual word is substantially similar to a keypoint descriptor located within a certain image, the image most likely contains an instance of the visual word.

The training module 112 is configured to define one or more object types (e.g., a car, motorbike, a face and the like). In some embodiments, each of the object models for defining an object type is represented as a probability distribution of one or more visual words present therein. A particular object type, such as a car, is modeled as a visual word probability distribution such that certain visual words, such as those representing wheels, a body, an engine and/or the like, are more likely to occur. Accordingly, a training image is abstracted or modeled as a collection of various objects in which each object is a collection of various visual words.

Each object model 114 accounts for variations in visual word occurrence among objects of the same object type. The object model of a particular object type specifies the probability of each visual word to occur in an object of the particular object type. The detection of the object is not exclusively concluded from the existence or non-existence of a particular visual word in the image. For example, suppose the object model of human face asserts that a particular visual word occurs very often in the lip of the human face, the occurrence of this visual word in an image signifies a strong evident that a human face exists in the image. However, even if the visual word does not occur in the image because, for example, the lip is occluded by another object in the image, our scheme may still declare that the image contains a human face if there are sufficient supporting evidence due to the occurrence of other visual words. Therefore, the use of the object models 114 makes object detection and localization more robust and flexible.

The examination module 116 includes software code (e.g., processor-executable instructions) for extracting visual words from images and detecting objects within the images using the object models 114. With respect to the image 108, the examination module 116 estimates a likelihood (i.e., a probabilistic score) of a given object type being present based on the visual word occurrence frequencies 126 (i.e., a frequency distribution of observed visual word occurrences represented by a histogram).

Simply stated, the examination module 116 uses the visual word dictionary 110 to count a number of occurrences of each visual word within the image 108, which is stored as the visual word occurrence frequencies 126. By modeling a visual word distribution of the entire image 108 as a mixture of various object models 114, the examination module 116 determines probabilities (i.e., weights) for such a mixture by maximizing a joint likelihood of the occurrences of the visual words in the image, as summarized by the visual word occurrence frequencies 126.

After the examination module 116 detects the existence of an object, the localization module 122 locates the object in the image 108. Initially, the localization module 122 uses a segmentation technique to partition the image 108 into plurality of small and homogeneous regions (i.e., pixel groupings). The localization module 122 includes software code (e.g., processor-executable instructions) for identifying one or more regions (i.e., segmented regions) of the image 108 that form the object. Once the one or more regions are identified, the localization module 122 couples the indicia of location 120 to the image 108. For example, if it is determined that the image 108 includes a face, the localization module 122 identifies one or more regions that form the face. Then, the localization module 122 displays information on the image 108 informing a user as to a position of the one or more regions. The localization module 122 may also modify pixel information corresponding to the one or more regions to accentuate (i.e., highlight) the face. For example, the localization module 122 may darken a border surrounding the face.

In order to identify the one or more regions for a detected object, the localization module 122 performs a similarity comparison between the object model 114 of a corresponding object type and visual word distributions associated with various subsets of regions within the image 108. For each subset of regions within the image 108, the localization module 122 counts an occurrence frequency of each visual word, defined in the visual word dictionary 110. Then, the localization module 122 normalizes the occurrence frequencies of the visual words by the total number of visual words in the regions and stores the normalized results in the image visual word distributions 118.

Based on the similarity comparison, the localization module identifies two or more connected regions that correspond with a minimal dissimilarity between the corresponding object model 114 and a visual word distribution of such regions according to some embodiments. The two or more connected regions are then merged to form the detected object. In some embodiments, the localization module 122 may employ various similarity cost functions (e.g., a Kullback-Liebler divergence) to minimize the dissimilarity as explained further below in the description of FIG. 2.

FIG. 2 illustrates a process 200 for detecting and localizing an object within an image 202 in accordance with one or more embodiments of the invention. As explained below, a training module (e.g., the training module 112 of FIG. 1) performs step 208 to step 214. A plurality of training images 204 is provided to the training module to create a dictionary of visual words. The training module also determines one or more object models 206 (e.g., probabilistic models) for object types of interest. An examination module (e.g., the examination module 116 of FIG. 1) receives the image 202 as input and performs pre-processing at step 216 and object detection at step 218. At step 216, the process 200 extracts the visual words from the image 202. At step 218, the process 200 detects which object types exist in the image 202. Subsequently, a localization module segments the image 202 into a set of homogenous regions at step 220. Then, the localization module (e.g., the localization module 122 of FIG. 1) identifies the subset of regions that forms the location of each detected object type at step 224.

The training images 204 comprising a plurality of objects are provided as an input to step 212. For each training image 204, step 212 detects each and every keypoint and computes a descriptor for each keypoint. Then, a clustering operation is performed on the set of all keypoint descriptors in order to define the set of visual words in use with the system. In some embodiments, the training module clusters or groups one or more proximate keypoint descriptors together and forms a visual word to represent the grouped keypoint descriptors. The resulting set of visual words, referred to as the visual word dictionary D, is used as an input for both step 210 and step 216, as explained further below.

The training images 204 are also provided as an input for step 210 where visual words in the training images 204 are extracted. Similar to step 216, for each training image 204, the training module first detects each and every keypoint and computes a descriptor for each keypoint in step 210. Based on the visual word dictionary, the training module represents each detected keypoint descriptor by the visual word to which the keypoint descriptor is most similar (referred to as quantization).

The training images 204 are also provided as input to step 208, at which manual object segmentation is performed. The process 200 defines a finite set of object types, Z, which the users may be concerned with. Objects that are of no concern will be assigned to a special object type referred to as background. At step 208, the pixels of the training images are classified to the different object types the system defines. In some embodiments, the results of segmenting a training image are specified by a separate image, referred to as the segmentation map, which has the same size as the training image. A distinct integer, referred to as the object label, is first selected to represent each object type. For each object type, the regions in the training image corresponding to the object type will be identified. Finally, the pixels in the corresponding regions in the segmentation map will be assigned the value equal to the object label of the object type. For example, the segmentation map may be an image equal in size to the training image where pixels in regions that correspond with a background have a value of zero, pixels in regions that correspond with an object (e.g., a dog) have a value of one and pixels in regions that correspond with another object (e.g., a cat) have a value of two.

At step 214, the process 200 computes the probabilistic models, referred to as the object models, of the various object types as defined in Z. The object model of a particular object type is the probability distribution of the visual words which occurs in the training image regions corresponding to the object type (i.e. the relative occurrence frequencies of the visual words). In step 214, for each object type z and each visual word w defined in the visual word dictionary D, the training module first counts the occurrence frequency c_{z,w} of the visual word w in all the training image regions corresponding to the object type z. The regions corresponding to the object type z are specified by the segmentation maps resulting from step 208. After counting the occurrence frequencies of all the visual words for the object type z, the object model p(w|z) for object type z can be computed as

$$p ( w \vert z ) = \frac{{σ}_{z , w}}{\text{?} {c}_{z , w}} . \\ \text{?} \text{indicates text missing or illegible when filed}$$

The training module stores the object models for the different defined object types, as mentioned in the description for FIG. 1, for use with the analysis and processing of any new input image 202.

In some embodiments, an examination module (e.g., the examination module 116 of FIG. 1) perform steps 216 to 218 during which the image is analyzed to detect presence of objects. In other embodiments, one or more steps may be skipped or omitted. Generally, a visual word distribution p(w|d) of any image d may be modeled as a mixture of the object models p(w|z) of one or more defined object types z. Therefore, the object models (i.e., visual word distributions) combine to represent the image d. Specifically, the image d is modeled as the following equation where Z is an index set of objects types z:

$$p ( w \vert d ) = {\sum }_{z ∈ Z} p ( w \vert z ) p ( z \vert d )$$

At step 216, the process 200 extracts visual words from the image 202. During step 216, the examination module detects each and every keypoint within the image 202, computes a descriptor for each keypoint and quantizes the descriptor to a visual word such that the visual word now represents the descriptor. As a result, the specific visual word now represents the descriptor during a remainder of the process 200. At step 218, the process 200 computes the maximum likelihood (ML) estimates of the mixture weights p(z|d) of the visual word distributions of the image 202 using a Expectation-Maximization algorithm. The mixture weight p(z|d) is a probability that an object of type z is present within the image 202. Therefore, after computing the ML estimate of p(z|d), if such an estimate exceeds a pre-defined threshold, the object type z is declared to be present.

In some embodiments, a localization module (e.g., the localization module 122 of FIG. 1) performs steps 220 to 222 during which the image 202 is segmented into a set S of regions 222 and locations of the detected object types in the image are identified. The regions 222 are homogeneous and outnumber the number of objects in the image, and therefore, this type of segmentation may also be referred to as over segmentation. As illustrated in FIG. 2, each segmented region of the image 202 typically includes one or more of the visual words 221 extracted during step 216. At step 224, the method 200 classifies and merges one or more of the regions 222. For each object of type z whose presence is affirmed during step 218, the process 200 identifies a connected subset 226 S_{z} of regions 222 S, which minimizes a cost function, as a location of the object z. In some embodiments, the cost function reflects a similarity between the object model (i.e., visual word distribution) of the object type z and the visual word distribution of the connected subset 226 of the regions 222.

In one embodiment, Kullback-Leibler (K-L) divergence is selected as the cost function for determining the similarity or consistency between the object model and the visual word distribution for one or more of the regions 222 (i.e., a subset) of the segmented image 202. After segmenting the image 202 into a plurality of regions 222, the process 200, at step 224, identifies a subset of regions S_{z} that forms the object z by minimizing the K-L divergence from the visual word distribution p(w|S_{z}) to the object model p(w|z) by solving the following minimization problem:

$${S}_{z} = {argmin}_{{s}^{t} ∈ s} \text{?} [ ( p ( w \vert {S}^{′} ) \vert \vert p ( w \vert z ) ] \\ \text{?} \text{indicates text missing or illegible when filed}$$

In the above minimization problem, the K-L divergence, from probability mass functions (pmf) p(w) to pmf q(w), is defined by the following equation:

$${D}_{KL} ( p \vert \vert q ) = {\sum }_{w} p ( w ) log \frac{p ( w )}{q ( w )} = {\sum }_{w} [ p ( w ) log p ( w ) - p ( w ) log q ( w ) ]$$

Furthermore, in an alternative embodiment, the subset of regions, S_{z}, that forms the object z is identified by the following minimization:

$${S}_{z} = {argmin}_{{s}^{t} ∈ s} {D}_{KL} [ p ( w \vert {S}^{t} ) \vert \vert p ( w \vert z ) ] + {D}_{KL} [ p ( w \vert S \backslash {S}^{t} ) \vert \vert p ( w \vert {z}_{background} ) ]$$

In such minimization, p(w|z_{background}) is an object model for a special background object type Z_{background}. As a result, after step 224, a connected subset of regions S_{z} is identified for each detected object z. One or more remaining regions which do not belong to any identified subsets form the background. Each connected subset 226 of the regions 222 indicates a presence and a location of a detected foreground object within the image 202 according to one or more embodiments.

FIG. 3 illustrates a flow diagram of a method 300 for defining visual words and creating object models in accordance with one or more embodiments. The method starts at step 302 and proceeds to step 304. At step 304, training images (e.g., training images 204 of FIG. 2) are accessed. At step 306, keypoints are identified. The keypoints generally include points or regions in an image which possess certain salient properties, such as invariance to affine transformation, invariance to view point changes and/or the like. In one embodiment, affine/scale covariant interest points are detected as keypoints within the training images. At step 308, descriptors are computed for the keypoints. A keypoint descriptor is generally a vector that is computed from pixels surrounding a corresponding keypoint. Furthermore, the keypoint descriptor captures relevant information for object detection such as a gradient magnitude and a gradient direction for the corresponding keypoint as well as a gradient magnitude histogram and a gradient direction histogram for pixels within a local region associated with the corresponding keypoint.

The method 300 proceeds to step 310 and performs clustering of all of the keypoint descriptors that are extracted from the training images. The training module uses a clustering technique (e.g., K-means clustering) to identify clusters (i.e., groups) of keypoints whose descriptors are substantially similar to each other. Repeated occurrences of similar keypoint descriptors, which are identified by the clustering technique and grouped in a cluster, suggests an important image feature for use in visual word and/or object detection.

At step 312, the method 300 defines one or more visual words. In some embodiments, the method 300 defines a visual word for each cluster that is identified during step 310. In some embodiments, the method 300 computes the visual word as a sample mean of the keypoint descriptors grouped in the cluster. The visual word of a cluster serves as a representative of all the keypoint descriptors grouped in the cluster. As such, the fine variations of keypoint descriptors grouped in clusters are discarded. The set of all visual words identified during step 312 will be referred to as the visual word dictionary D.

The method 300 proceeds to perform step 314 to step 324 as illustrated in FIG. 3B. At step 314, the set of training images is accessed. Alternatively, the method 300 may employ a second set of training images for visual word extraction and object modeling. At step 316, an image is processed. At step 318, keypoints are detected. At step 320, a descriptor is computed for each detected keypoint. Step 318 and step 320 perform operations similar to step 306 and step 308, respectively, according to some embodiments.

At step 322, the method 300 quantizes each keypoint descriptor to a visual word defined in the visual word dictionary. The method 300 compares each keypoint descriptor in the training image being processed with every visual word, and represents the keypoint descriptor by the visual word which is most similar to the keypoint descriptor. After step 322, the method 300 extracted all the visual words in the training image being processed, and proceeds to step 324. At step 324, the method 300 determines whether there are more unprocessed training images. If there are additional training images to be processed, the method 300 returns to step 316. If, on the other hand, there are no more unprocessed training images, the method 300 proceeds to step 326 in FIG. 3C.

The method 300 proceeds to perform step 326 to step 340 as illustrated in FIG. 3C. FIG. 3C illustrates a method to generate the object models from the segmentation maps and the visual word dictionary. At step 326, the method 300 initializes frequency distributions (i.e., a visual word occurrence frequency) c_{z,w} to zero for each object type z in Z and each visual word w in D. At step 328, the method 300 accesses a training image and a corresponding segmentation map. The corresponding segmentation map identifies regions of the training image that include a particular object (type). An object model for the particular object type is a probability distribution of the visual words which occurs in the training image regions corresponding to the object type, i.e. the relative occurrence frequencies of the visual words.

At step 330, the method 300 determines an object type z for each visual word w that is extracted from the current training image. Suppose the visual word w is located at pixel s in the image, the object type z for the visual word w is given by an object label associated with the pixel s in the segmentation map. At step 332, the method 300 updates the frequency distribution to account for the visual words that are located within the training image. For each visual word w in the training image, suppose its object type is z, method 300 increment the frequency distribution c_{z,w} by 1 (i.e. c_{z,w}←C_{z,w}+1). Ultimately, the corresponding frequency distribution increases by a number of occurrences of each visual word located within the object type z.

At step 334, the method 300 determines whether there are more images in the set of training images. If the method 300 determines that there are additional training images to be analyzed, the method 300 returns to step 328. If, on the other hand, the method 300 determines that there are no more training images, the method 300 proceeds to step 336. At step 336, the method 300, for each object type z, computes a total number of associated visual words that occur in the training images using the equation [symbol] . Then, at step 338, the method 300 generates an object model for each object type z by normalizing the frequency distributions. In one embodiment, the examination module computes

$$p ( w \vert z ) = \frac{\text{?}}{{N}_{Z}} . \\ \text{?} \text{indicates text missing or illegible when filed}$$

At step 340, the method 300 ends.

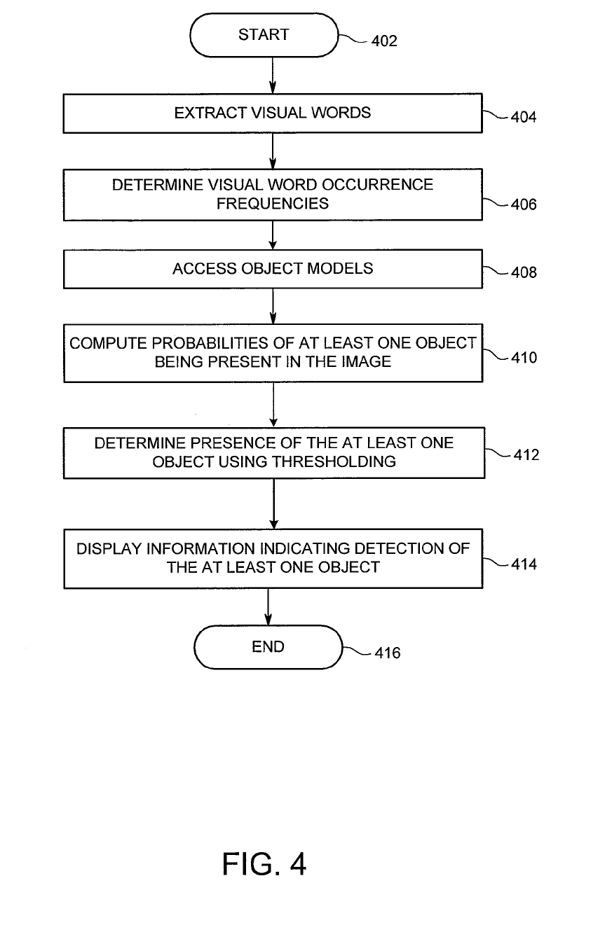

FIG. 4 illustrates a flow diagram of a method 400 for detecting an object within the image in accordance with one or more embodiments of the invention. The method 400 is an exemplary embodiment of step 216 to step 218 of FIG. 2. The method 400 starts at step 402 and proceeds to step 404.

At step 404, the method 400 examines an image and extracts visual words from the image. In some embodiments, the method 400 receives an image and detects keypoints within the image. Then, the method 400 computes a descriptor for each detected keypoint and quantizes the computed keypoint descriptor to a representative visual word in a visual word dictionary D. The method 400 performs visual word extraction in a substantially similar manner as step 318, step 320, and step 322 of the method 300 as explained in the description for FIG. 3, except that the method 400 is executed on new input images instead of training images and configured to detect objects in the new input images.

At step 406, the method 400 determines occurrence frequencies for the different visual words in the input image. Specifically, for each visual word w defined in the visual word dictionary D, the method 400 counts a number of occurrences, c_{w}, of the visual word in the input image. These occurrence frequencies may be stored as visual word occurrence frequencies (e.g., the visual word occurrence frequencies 126 of FIG. 1). At step 408, the method 400 accesses one or more object models for any number of object types in Z.

At step 410, the method 400 determines one or more objects that are very likely to be present within the image based on frequencies associated with the visual words therein. At step 410, the method 400 estimates a probability of the input image containing one or more objects of each object type. In one or more embodiments, the method 400 computes the maximum likelihood (ML) estimate of the probability of an object to occur in the image. Specifically, the method 400 assumes a probabilistic model for the input image d:

$$p ( w \vert d ) = \text{?} p ( w \vert z ) p ( z \vert d )$$

$$\text{?} \text{indicates text missing or illegible when filed}$$

In this probabilistic model, p(w|z) is the object model for the object type z obtained from step 214 of FIG. 2 according to some embodiments. The term p(z|d) is the probability of the image d to contain one or more object instances of the object type d. The log-likelihood of p(z|d) given the observed visual words in the image is:

$$L = {\sum }_{e ∈ D} {c}_{w} log ( p ( w \vert \vert d ) )$$

The ML estimate of p(z|d) is defined as the value of p(z|d), which maximizes the log-likelihood function L shown above. The ML estimate of p(z|d) for each object type z is then computed by an Expectation-Maximization (EM) technique.

Because p(z|d) represents a probability that a particular object of type z is present within the image d, the method 400 determines whether the image d includes the particular object of type z by comparing p(z|d) with a predefined threshold during step 412. If the probability p(z|d) exceeds the predefined threshold, the method 400 determines that the particular object of type z exists in the image. Otherwise, the method 400 determines that the particular object of type z does not exist in the image. Next, in step 414, the method 400 displays information indicating which object types are in the image. At step 416, the method 400 ends.

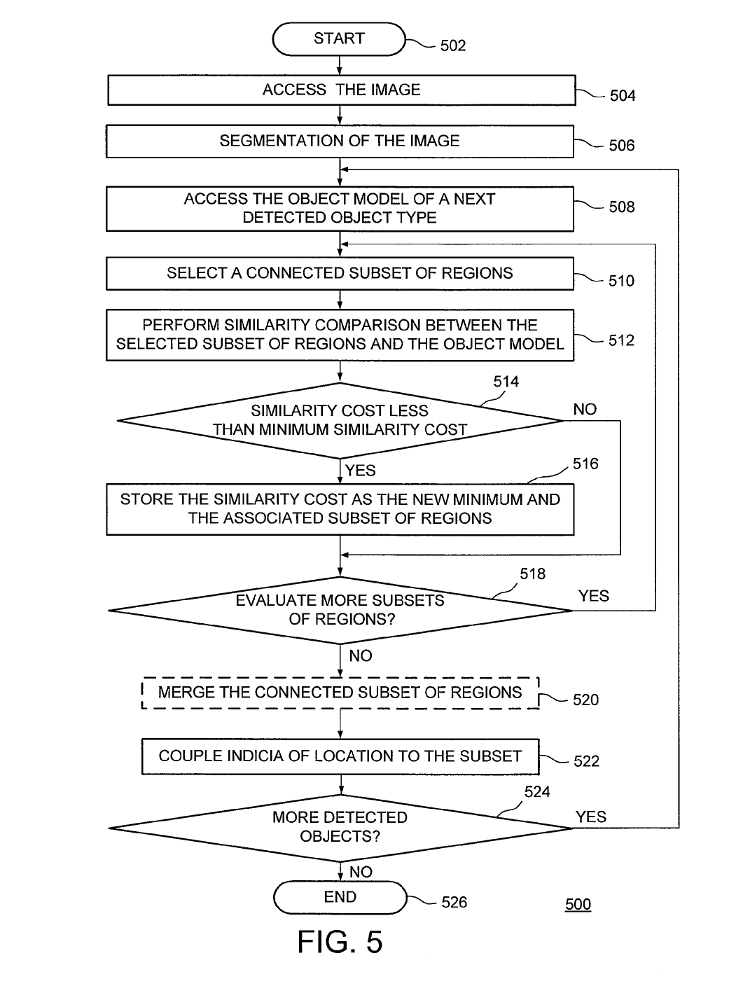

FIG. 5 is a flow diagram of a method 500 for identifying regions of an image that form an object in accordance with various embodiments. In some embodiments, the method 500 is performed after an object, such as a foreground object, is detected within the image. As soon as an examination module detects such an object within the image, a localization module performs the method 500 to locate an object according to some embodiments.

As explained with more detail in the following description, the method 500 locates each detected object in the image. The method 500 first segments the image into a plurality of homogenous regions S and identifies one or more regions, S_{z}, such that a visual word distribution of S_{z} is as similar as possible to an object model of a current object, as measured by an appropriately chosen similarity cost function. In some embodiments, the visual word distribution of S_{z} is stored in image visual word distributions (e.g., the image visual word distributions 118 of FIG. 1).

In some embodiments, S_{z} is a connected subset of regions that minimize a dissimilarity between the visual word distribution for S_{z} and the object model of the current object type z using the following similarity cost function:

[symbol]

The method 500 starts at step 502 and proceeds to step 504. At step 504, the method 500 accesses the input image. At step 506, the method 500 performs image segmentation to partition the input image into the plurality of homogenous regions S. Any generic, well-known segmentation algorithm, for example, the normalized-cut segmentation algorithm or the efficient graph-based segmentation algorithm, may be used to segment the image at step 506.

After step 506, for each detected object of type z in the image, the method 500 identifies the connected subset of regions, S_{z}, from a set of the plurality of segmented regions, S, as a location. At step 508, the method 500 accesses an object model, p(w|z), of a next detected object z. In some embodiments, the method 500 successively performs similarity comparisons on various connected subsets of S and identifies a particular subset having a visual word distribution that is most similar to the object model of the next detected object z as explained further below.

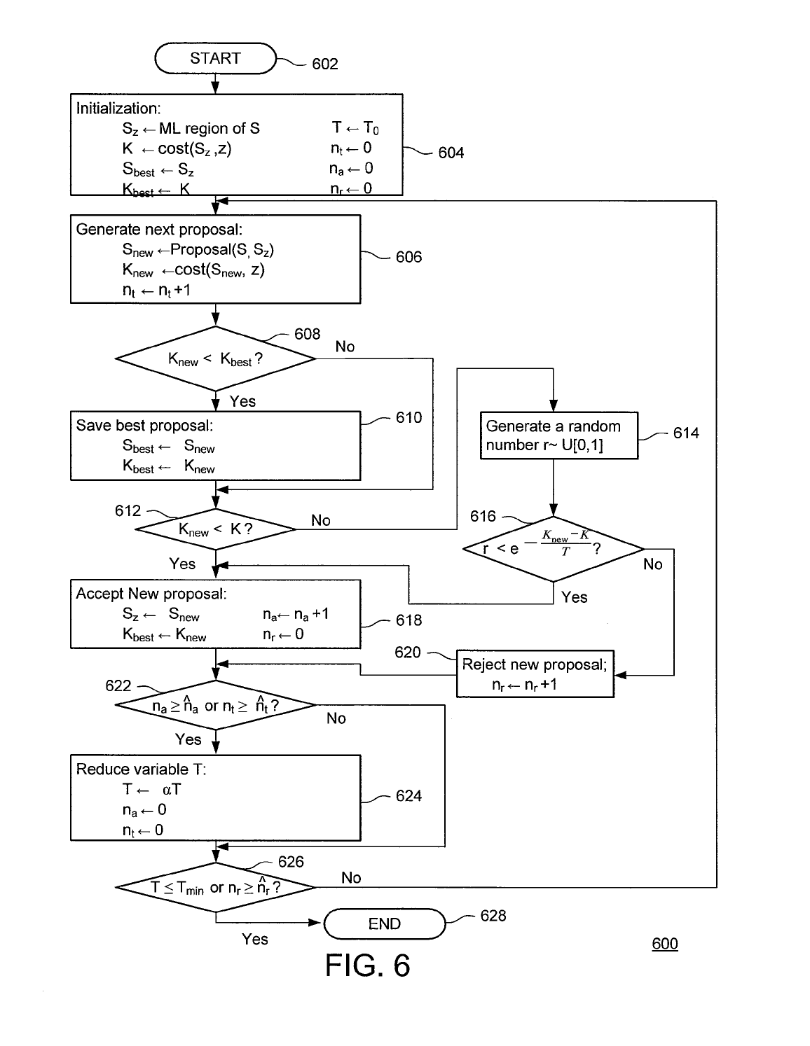

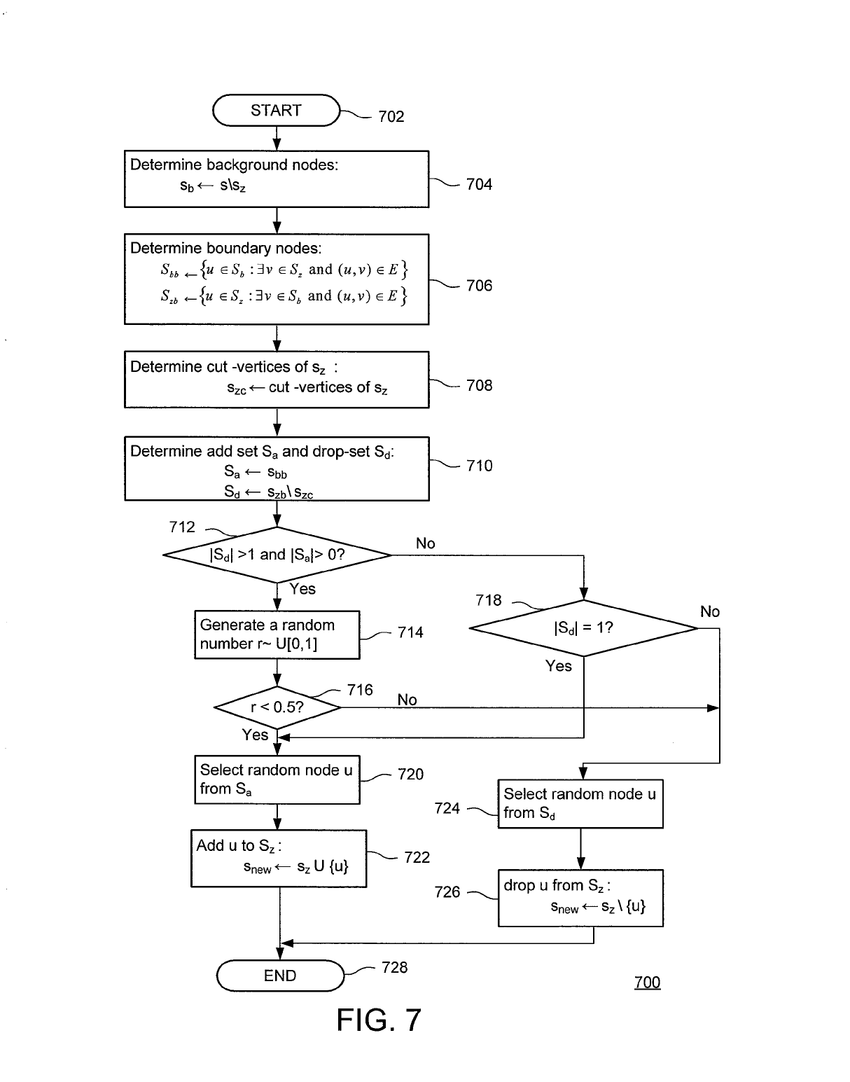

At step 510, the method 500 selects the one or more regions, S_{z} from the set of all segmented regions S. In some embodiments, the method 500 does not select each and every possible subset of S for the similarity comparison in order to limit the computational cost. Embodiments related to various techniques for selecting the various connected subsets are explained in the descriptions for FIG. 6 and FIG. 7.

At step 512, the method 500 performs a similarity comparison between a visual word distribution of the selected one or more regions and the object model p(w|z) of the next detected object. In some embodiments, the method 500 performs the similarity comparison by first computing an empirical probability distribution of the visual words, p(w|S_{z}), for the subset S_{z}, i.e. the number of occurrence of each visual word w in S_{z} divided by the total number of visual words in S_{z}, followed by computing the similarity cost function value cost(S_{z}, z). The similarity cost is selected to evaluate how similar p(w|S_{z}) and p(w|z) are to each other. In some embodiments, the similarity cost function cost(S_{z}, z) is based on the Kullback-Liebler(K-L) divergence and is given by the equation:

[symbol]

A higher value of the K-L divergence indicates a lower degree of similarity between p(w|S_{z}) and p(w|z). Hence, the method 500 minimizes the dissimilarity by repeating step 510 to step 518 until the connected subset, S_{z}, that is associated with a minimal K-L divergence is identified. In some embodiments, the method 500 applies an optimization method to this function in order to identify the one or more regions S_{z} that minimize the divergence.

In other embodiments, the similarity cost function is chosen as:

cos t(S_{z},z)=D_{KL}[p(w|S_{z})∥p(w|z)]+D_{KL}[p(w|S\S_{z})∥p(w|z_{background})]

In this equation, S\S_{z} represents the subset of regions that are not in S_{z}, p(w|S\S_{z}) is the empirical probability distribution of the visual words in S\S_{z}, z_{background} is the object type specially assigned for the image background, and p(w|z_{background}) is the object model for the background (object type). In either similarity cost function, a smaller cost function value indicates a higher similarity between p(w|S_{z}) and p(w|z).

At step 514, the method 500 compares the current similarity cost with the minimum similarity cost. If the current similarity cost is smaller than the minimum similarity cost, the method 500 replaces the minimum similarity cost with the current similarity cost and stores the current subset of connected regions at step 516. Otherwise, step 516 is skipped.

At step 518, the method 500 determines if more subsets of regions are to be evaluated. If more subsets of regions have to be evaluated, the method 500 proceeds to step 508 to select another connected subset of regions for evaluation. Otherwise, the method 500 proceeds to either optional step 520 or step 522. If the one or more regions S_{z} is a single region, the method 500 proceeds to step 522.

At step 522, the method 500 couples the one or more regions S_{z} associated with the minimal similarity cost with indicia of location. In some optional embodiments, the one or more regions S_{z} include two or more connected regions forming a continuous portion. At optional step 520, the method 500 merges these regions S_{z} to form at least a portion of the object. For example, the two or more regions are merged to form a boundary around the object. Then, at step 522, the method 500 couples the merged, connected subset of regions with the indicia of location. At step 524, the method 500 determines whether there are more detected objects in the image to be localized. If there is another detected object, the method 500 returns to step 508. At step 526, the method ends.

FIG. 6 is a flow diagram of a method 600 for identifying one or more region of an image that form an object in accordance with one or more embodiments. The method 600 represents an exemplary embodiment of step 224 of the method 200 as described for FIG. 2. The method 600 also represents an exemplary embodiment of steps 510-518 of the method 500 as described for FIG. 5. The method 600 is executed once for each object z that was detected during execution of step 218 of the method 200. The method 600 uses a segmentation map, which was produced during step 220 and visual words extracted from the image, which is an output of step 216, to locate each object z.

The segmentation map may be represented as a graph G(S, E). Specifically, each element in a set of nodes, S, represents a distinct region of the segmentation map. A set of edges of the graph, E, represents the neighborhood relationship between any two nodes u and v in S, i.e. the edge (u, v) belongs to E if and only if the two regions in the segmentation map corresponding to the two nodes u and v are neighboring to each other.

The method 600 applies the simulated annealing optimization algorithm to search for a connected subset of regions, [symbol] , such that the visual word distribution of such a subset, [symbol] , is most similar to the object model p(w|z) of the object z, according to a cost function cost(S_{z}, z) as described below. The method 600 stores a current solution S_{z}, and successively generates a new solution proposal S_{new from S}_{z}. The new proposal S_{new} will be either accepted or rejected depending on the cost function value evaluated for the new proposal. As the procedure successively evaluates different solutions, the best solution that has been observed will be stored in the variable S_{best}. On termination of the procedure, the value in S_{best} will be returned as the subset of regions S*_{z} that forms the object of the type z in the input image.

In more details, the method 600 starts at step 602 and proceeds to step 604 in which a number of variables are initialized. During the step 604, the current solution S_{z} is initialized with the single region u_{ML} ε S such that the set of visual words contained in u_{ML} has the highest likelihood under the object model p(w|z). The variable K is initialized with the corresponding cost function value of the current solution. The best solution S_{best} and the corresponding best cost function value K_{best} are initialized by the values of S_{z} and K respectively. The operation of the method 600 also depends on the variables T, nₐ, nᵣ, and nₜ, which are initialized to a predefined value T₀ for T and 0 for nₐ, nᵣ, and nₜ at step 704.

The cost function cost (S_{z}, z) evaluates a similarity between the probability distribution of the visual words contained in the subset S_{z} and the object model for object z. In some embodiments, this cost function is selected as the KL-divergence from p(w|S_{z}) to p(w|z):

[symbol]

In alternative embodiments, the cost function is selected as:

[symbol]

In this cost function, p(w|S\S_{z}) is the visual word distribution of the remaining regions in S and p(W|z_{background}) is the object model for the special background object type z_{background}.

After initialization at step 604, the method 600 proceeds to step 606 during which the method 600 generates a new solution proposal S_{new} and computes the corresponding cost function value K_{new}. The proposal is generated from the current solution S_{z} either by dropping a node from S_{z} or adding a node from S\S_{z} to S_{z}. The method to generate the new proposal will be described in detail below with FIG. 7. During step 606, the method 600 also increments the variable nₜ by one (1). The variable nₜ keeps track of the number of new proposals generated since the last change of the variable T.

Next, in step 608, the method 600 compares the cost function value K_{new} for the new proposal with the cost function value K_{best} for the best solution. If K_{new} is less than K_{best}, the proposal solution is better than the best solution that the method 600 has visited thus far. Then, the method 600 saves the proposal solution as the best solution and the corresponding cost function value as the best cost function value in step 610. Otherwise, step 610 is skipped according to some embodiments.

The method 600 continues to step 612 in which the method 600 compares the cost function value K_{new} of the new proposal with the cost function value K of the current solution. If K_{new}<K, the new proposal is accepted. Then, method 600 proceeds to step 618 to update the current solution S_{z} by the new proposal solution S_{new}, update the current cost function value K by K_{new}, increment the variable nₐ by 1, and reset the variable nᵣ to 0. However, if K_{new}≧K in step 612, the method 600 proceeds to step 614 in which the method 600 samples a random number r following the uniform distribution on the range [0, 1]. Next, in step 618 the method 600 compares r with the quantity

$$exp ( - \frac{{K}_{new} - K}{τ} ) . If r < exp ( - \frac{{K}_{new} - K}{τ} ) ,$$

the method 600 continues to step 618 to accept the proposal solution despite its cost function value K_{new} is greater than the current cost function value K.

$$If r \geq exp ( - \frac{{K}_{new} - K}{τ} ) ,$$

the method 600 continues to step 620 to reject the proposal solution and increment the variable nᵣ by 1.

After the method 600 finishes either step 618 or step 620, the method 600 proceeds to step 622 to compare the variables nₐ and nₜ with two predefined values \hat{η}ₐ and \hat{n}ₜ. If nₐ≧\hat{η}ₐ or ηₜ≧\hat{η}ₜ, the method 600 continues to step 624 to update the variable T to αT, where 0<α<1, and reset both nₐ and nₜ to 0. However, in step 622, if the condition nₐ≧\hat{η}ₐ or nₜ≧\hat{η}ₜ does not hold, the step 624 is skipped.

Finally, at step 626, the method 600 evaluates the condition T≧Tₘᵢₙ or nᵣ≧\hat{η}ᵣ. If the condition holds true, the method 600 proceeds to step 628, terminates the procedure, and returns the best solution S_{best}. Otherwise, if the condition in step 626 does not hold, the method 600 proceeds to step 606 and executes the next iteration.

FIG. 7 illustrates a flow diagram of a method 700 for generating a new proposal solution S_{new} from the current solution S_{z} for use in a simulated annealing process according to one or more embodiments. The new proposal solution is used in the step 706 of the method 700 as described in FIG. 6. The proposal solution is generated either by dropping a node from S_{z}, or by adding a node from S\S_{z} to S_{z}. The generated solution S_{new} must satisfy two requirements. First, S_{new} must contain at least one node of S. Second, the nodes in S_{new} form a single connected component, i.e. for any two nodes u and v in S_{new}, they much be connected by a path such that all the intermediate nodes in the path are in S_{new}.

The method 700 starts at step 702 and proceeds to the step 704 in which the method 700 determines the set of background nodes S_{b}=S\S_{z}, i.e. the nodes which are in S but not in S_{z}. Next, at step 706, the method 700 computes the sets of boundary nodes of S_{b} and S_{z} respectively, defined by the following:

S_{bb}={u ε S_{b}: ∃v ε Sₐ and (u,v) εE}

S_{zb}={u ε Sₐ: v ε S_{b} and (u,v) ε E}:

In the above definitions, E is the set of edges in the graph representation of the segmentation map, G(S, E). At step 708, the method 700 then determines the set of cut-vertices of S_{z}, which is denoted by S_{zc}. A node u in S_{z} is a cut-vertex of S_{z} if the removal of the node u from S_{z} will leave the remaining nodes in S_{z} to form more than one connected component. The sets S_{bb}, S_{zb}, and S_{zc} are then used at step 710 to determine the add-set Sₐ, and the drop-set S_{d}, which are given by

Sₐ=S_{bb}

S_{d}=S_{zb}\S_{zc}

The add-set Sₐ contains the candidate nodes which can be added to S_{z} to form the new proposal solution. Similarly, the drop-set S_{d} contains the candidate nodes which can be dropped from S_{z} to generate the new proposal.

At step 712, the method 700 verifies if there are more than 1 elements in the drop-set, i.e. |S_{d}|>1, and there are some elements in the add-set, i.e. |Sₐ|>0. If the condition at step 712 holds, the method 700 can generate S_{new} by either adding a node to S_{z} or dropping a node from S_{z}. The decision is made in step 714 and step 716. At step 714, a random number r is sampled from the uniform distribution with range [0, 1]. At step 716, the method 700 compares r with 0.5. If r<0.5, the method 700 proceeds to step 720. Otherwise, the method 700 proceeds to step 724. However, if the condition at step 712 does not hold, the method 700 will further verify whether |S_{d}|=1 at step 718. It should be noted that with |S_{d}|=1, the new proposal cannot be generated by dropping a node from S_{z}, because in that case, the proposal solution will be an empty set. Therefore, if |S_{d}|=1 at step 716, the method 700 proceeds to step 720, otherwise, the method 700 proceeds to step 724.

At step 720, the method 700 selects a node u randomly from the add-set Sₐ, which is then added to S_{z} to form the new proposal solution S_{new} at step 722. At step 724, the method 700 selects a node u randomly from the drop-set S_{d}, which is then dropped from S_{z} to form the new proposal solution S_{new} at step 726. Whether the method 700 finished step 722 or step 726, the method proceeds to step 728 to terminate the procedure, and returns the new proposal solution S_{new}.

While, the present invention is described in connection with the preferred embodiments of the various figures. It is to be understood that other similar embodiments may be used. Modifications/additions may be made to the described embodiments for performing the same function of the present invention without deviating therefore. Therefore, the present invention should not be limited to any single embodiment, but rather construed in breadth and scope in accordance with the recitation of the appended claims.

1. A computer implemented method for localizing objects within an image, comprising:
accessing at least one object model representing visual word distributions of at least one training object within training images;
detecting whether an image comprises at least one object based on the at least one object model;
identifying at least one region of the image that corresponds with the at least one detected object and is associated with a minimal dissimilarity between the visual word distribution of the at least one detected object and a visual word distribution of the at least one region; and
coupling the at least one region with indicia of location of the at least one detected object.

2. The method of claim 1, wherein detecting whether the image comprises the at least one object further comprising:
extracting visual words from the image to determine visual word occurrence frequencies;
for each object of the at least one object model, computing a likelihood of being present within the image based on the visual word occurrence frequencies; and
identifying an object having a likelihood that exceeds a predefined threshold.

3. The method of claim 1, wherein the at least one identified region are connected and form a continuous portion of the image.

4. The method of claim 1, wherein identifying the at least one region of the image further comprises for each of the at least one detected object, performing a similarity comparison between a corresponding visual word distribution of the at least one object model and image visual word distributions.

5. The method of claim 4, wherein identifying the at least one region further comprises repeating the performing step for at least one subset of regions within the image.

6. The method of claim 4, wherein performing the similarity comparison further comprises computing a similarity cost between the corresponding visual word distribution of the at least one object model and the visual word distribution of the at least one region.

7. The method of claim 6, wherein the similarity cost comprises a Kullback-Leiber divergence from the corresponding visual word distribution of the at least one object model to the visual word distribution of the at least one region.

8. The method of claim 1 further comprising merging the at least one identified region to form the at least one object.

9. A computer implemented method of localizing objects within an image, comprising:
extracting visual words from an image to determine a visual word distribution;
segmenting the image into a plurality of regions, wherein each of the plurality of regions comprises at least one of the extracted visual words;
minimizing a dissimilarity between at least one object model for defining at least one object and at least one visual word distribution for at least one region of the plurality of regions, wherein the at least one region forms the at least one object;
coupling the at least one region with indicia of location as to the at least one object.

10. The method of claim 9 further comprising merging the at least one region, wherein the at least one region are connected.

11. The method of claim 9, wherein minimizing the dissimilarity further comprises for each of the at least one detected object, performing a similarity comparison between a corresponding visual word distribution of the at least one object model and an image visual word distribution.

12. The method of claim 11, wherein identifying the at least one region further comprises repeating the performing step for at least one subset of regions within the image.

13. An apparatus for localizing objects within an image, comprising:
an examination module for accessing at least one object model representing visual word distributions of at least one training object within training images and detecting whether an image comprises at least one object based on the at least one object model; and
a localization module for identifying at least one region of the image that corresponds with the at least one detected object and is associated with a minimal dissimilarity between the visual word distribution of the at least one detected object and a visual word distribution of the at least one region and coupling the at least one region with indicia of location of the at least one detected object.

14. The apparatus of claim 13, wherein the examination module extracts visual words from the image to determine visual word occurrence frequencies, computes, for each object of the at least one object model, a likelihood of being present within the image based on the visual word occurrence frequencies and identifies an object having a likelihood that exceeds a predefined threshold.

15. The apparatus of claim 13, wherein the at least one identified region comprises at least two connected regions of the image.

16. The apparatus of claim 15, wherein the localization module merges the at least two connected regions to form the at least one object.

17. The apparatus of claim 13, wherein the localization module, for each of the at least one detected object, performs a similarity comparison between a corresponding visual word distribution of the at least one object model and image visual word distributions.

18. The apparatus of claim 17, wherein the localization module repeats the similarity comparison for at least one subset of regions within the image.

19. The apparatus of claim 17, wherein the localization module computes a similarity cost between the corresponding visual word distribution of the at least one object model and the visual word distribution of the at least one region.

20. The apparatus of claim 19, wherein the similarity cost comprises a Kullback-Leiber divergence from the corresponding visual word distribution of the at least one object model to the visual word distribution of the at least one region.
